(19) United States
(12) Patent Application Publication
(10) Pub. No.: US 2021/0160235 A1
(43) Pub. Date: May 27, 2021

(54) USER-WEARABLE DEVICES ASSURING AUTHENTICATION AND VALIDATION OF DATA STORAGE AND TRANSMISSION THAT UTILIZE BLOCKCHAIN

(71) Applicant: Daniel Maurice Lerner, Missouri City, TX (US)

(72) Inventor: Daniel Maurice Lerner, Missouri City, TX (US)

(21) Appl. No.: 17/045,647

(22) PCT Filed: Apr. 8, 2019
(86) PCT No.: PCT/US2019/026270

§ 371 Date: Oct. 6, 2020

Related U.S. Application Data
(63) Continuation-in-part of application No. 16/376,399, filed on Apr. 5, 2019, now Pat. No. 10,536,445.
Application No. 16/376,399 is a continuation of application No. 16/173,091, filed on Oct. 29, 2018, now Pat. No. 10,601,805.
Application No. 16/173,091 is a continuation of application No. 16/005,040, filed on Jun. 11, 2018, now Pat. No. 10,154,021.
Application No. 16/376,399 is a continuation of application No. 16/173,384, filed on Oct. 29, 2018, now Pat. No. 10,623,384.
Application No. 16/173,384 is a continuation of application No. 16/006,011, filed on Jun. 12, 2018, now Pat. No. 10,158,613.
Application No. 16/006,011 is a continuation-in-part of application No. 16/005,040, filed on Jun. 11, 2018, now Pat. No. 10,154,021.
Application No. PCT/US2019/026270 is a continuation of application No. 16/178,795, filed on Nov. 2, 2018, now Pat. No. 10,637,854.
Application No. 16/178,795 is a continuation of application No. 16/005,281, filed on Jun. 11, 2018, now Pat. No. 10,154,031.
Application No. 16/005,281 is a continuation-in-part of application No. 16/005,040, filed on Jun. 11, 2018, now Pat. No. 10,154,021.
Application No. 16/005,040 is a continuation-in-part of application No. 16/005,134, filed on Jun. 11, 2018, now Pat. No. 10,171,444.
Application No. 16/005,134 is a continuation-in-part of application No. 16/005,040, filed on Jun. 11, 2018, now Pat. No. 10,154,021.
(60) Provisional application No. 62/654,100, filed on Apr. 6, 2018.
(60) Provisional application No. 62/653,144, filed on Apr. 5, 2018.
(60) Provisional application No. 62/518,281, filed on Jun. 12, 2017.
(60) Provisional application No. 62/540,352, filed on Aug. 2, 2017.
(60) Provisional application No. 62/518,371, filed on Jun. 12, 2017.
(60) Provisional application No. 62/518,281, filed on Jun. 12, 2017.
(60) Provisional application No. 62/518,337, filed on Jun. 12, 2017.

(51) Int. Cl. H04L 29/06; H04L 9/08; H04L 9/14; G06F 16/27; G06F 21/53

(52) U.S. Cl. CPC H04L 63/0861; H04L 9/0866; H04L 9/14; H04L 63/20; H04L 63/08; H04L 63/104; H04L 63/0428; G06F 21/53; H04L 9/0819; H04L 63/0876; H04L 9/088; G06F 16/27

(57) ABSTRACT

Described are user-wearable devices utilizing protected authentication techniques to ensure security of any data communication to and from these devices that utilize one or more blockchains. The securitized blockchains can be either real or virtual devices. The user-wearable devices communicate using digital signals. In order to provide privacy and security of these signals, unique encryption technology is employed together with the use of biometrics that are contained within, along, or external to one or more blockchains and associated with each user. The biometric data transceivers are capable of reading a user's encrypted biometric data and then transmitting the encrypted data either via one or more blockchains or one or more encrypted blockchains to a user identity validation distributed auto-synchronous array (DASA) database which allows for decryption, identification, and authentication of both the user(s) and the communication(s).

### PRIORITY STATEMENT

This application is a U.S. National Phase 371 filing of PCT/US2019/026270 filed Apr. 8, 2019, which is an international PCT conversion of and takes priority under 119(e) of U.S. Provisional Application No. 62/654,100 filed Apr. 6, 2018, entitled “User-Wearable Secured Devices Provided with Encryption Assuring Authentication and Validation of Data Storage and Transmission that Utilize Blockchain”.

This application is also a continuation-in-part of U.S. Nonprovisional application Ser. No. 16/376,399 filed Apr. 5, 2019 and granted as U.S. Pat. No. 10,536,445 on Jan. 14, 2020, entitled, “Discrete Blockchain and Blockchain Communications”, which is a nonprovisional conversion of U.S. Provisional Application No. 62/653,144 filed Apr. 5, 2018 and entitled, Managed Securitized and Encrypted Blockchain and Blockchain Communications”.

This application is also a continuation of U.S. Nonprovisional application Ser. No. 16/173,091 filed Oct. 29, 2018, which is a continuation of Ser. No. 16/005,040, filed Jun. 11, 2018 and granted as U.S. Pat. No. 10,154,021 on Dec. 11, 2018, entitled “Securitization of Temporal Digital Communications with Authentication and Validation of User and Access Devices”, which is a nonprovisional conversion of U.S. Provisional Application entitled “A System for Securing and Encrypting Temporal Digital Communications with Authentication and Validation of User and Access Devices” with Ser. No. 62/518,281 filed Jun. 12, 2017.

This application is as also continuation of U.S. patent application Ser. No. 16/178,795, filed Nov. 2, 2018 and granted as U.S. Pat. No. 10,637,854 on Apr. 28, 2020, which is a continuation of Ser. No. 16/005,281 filed Jun. 11, 2018 and granted as U.S. Pat. No. 10,154,031 on Dec. 11, 2018, which is a nonprovisional conversion of and takes priority under 119(e) of U.S. Provisional Application No. 62/518,371 filed Jun. 12, 2017 and entitled, “User-Wearable Secured Devices Provided with Encryption Assuring Authentication and validation of Data Storage and Transmission”.

U.S. patent application Ser. No. 16/005,281 is also a continuation-in-part of U.S. Nonprovisional application Ser. No. 16/005,134 filed Jun. 11, 2018 and entitled “Securitization of Temporal Digital Communications Via Authentication and Validation for Wireless User and Access Devices” which is a nonprovisional conversion of U.S. Provisional Application entitled “Securitizing Temporal Digital Communications Via Authentication and Validation for Wireless User and Access Devices” with Ser. No. 62/519,337, filed Jun. 12, 2017.

U.S. patent application Ser. No. 16/005,281 is also a continuation-in-part of U.S. Nonprovisional application Ser. No. 16/005,040, filed Jun. 11, 2018 and entitled “Securitization of Temporal Digital Communications with Authentication and Validation of User and Access Devices”, which is a nonprovisional conversion of U.S. Provisional Application entitled “A System for Securing and Encrypting Temporal Digital Communications with Authentication and Validation of User and Access Devices” with Ser. No. 62/518,281 filed Jun. 12, 2017.

This application is also a continuation of U.S. Nonprovisional application Ser. No. 16/202,905 filed Nov. 28, 2018 and granted as U.S. Pat. No. 10,645,070 on May 5, 2020, which is a continuation of Ser. No. 16/005,134 filed Jun. 11, 2018 and granted as U.S. Pat. No. 10,171,444 on Jan. 1, 2019, entitled “Securitization of Temporal Digital Communications Via Authentication and Validation for Wireless User and Access Devices” which is a nonprovisional conversion of U.S. Provisional Application entitled “Securitizing Temporal Digital Communications Via Authentication and Validation for Wireless User and Access Devices” with Ser. No. 62/518,337, filed Jun. 12, 2017.

Further, application Ser. No. 16/005,134, filed Jun. 11, 2018, granted as U.S. Pat. No. 10,171,444 on Jan. 1, 2019, is a continuation-in-part of U.S. Nonprovisional application Ser. No. 16/005,040 filed Jun. 11, 2018 entitled “Securitization of Temporal Digital Communications with Authentication and Validation of User and Access Devices”, granted as U.S. Pat. No. 10,154,021 on Dec. 11, 2018.

This application is also a continuation of U.S. Nonprovisional application Ser. No. 16/173,384 filed Oct. 29, 2019 and granted as U.S. Pat. No. 10,623,384 on Apr. 14, 2020, which is a continuation of Ser. No. 16/006,011, filed Jun. 12, 2018, granted as U.S. Pat. No. 10,158,613 on Dec. 18, 2018, is a continuation-in-part of U.S. Nonprovisional application Ser. No. 16/005,040 filed June 11, 2018 entitled “Securitization of Temporal Digital Communications with Authentication and Validation of User and Access Devices”, granted as U.S. Pat. No. 10,154,021 on Dec. 11, 2018.

All applications are hereby incorporated by reference in their entirety.

### FIELD

The present disclosure relates to functional, user-wearable devices that transmit, receive, store, and may temporarily contain data using techniques to protect as well as detect and allow only the proper user(s) of the data. Users of these devices are provided with authentication and validation security, even when the devices are not in use. Specifically, the present disclosure describes devices, methods, and systems for authenticating not only the identity of one or more users, but the ability to encrypt and decrypt data that is sent to, from, and held within these user-wearable devices and utilize one or more blockchains as needed. The blockchains may or not be securitized and are useful to protect the either real or virtual devices of the present disclosure. In this case, the blockchain(s) can be used together with the user-wearable system described to further enhance securitization or the user-wearable system can be used to enhance the overall security of the blockchain.

### BACKGROUND

The use of “smart” wearable devices has its historic origins in the use of analogue timepieces—including pocket and wrist watches. Most of the five hundred year old history of watches consisted of the development of the mechanical watch. Watches evolved from portable spring driven clocks, which first appeared in 15th-century Europe. Portable timepieces were made possible by the invention of the mainspring in the early 15th century and most likely were developed by German clockmaker Peter Henlein. The invention of the quartz watch in the 1960s, which ran on electricity and kept time with a vibrating quartz crystal, proved a radical departure for the industry. During the 1980s quartz watches took over the market from mechanical watches, an event referred to as the “quartz crisis”. The first digital electronic watch, a Pulsar LED prototype in 1970, was developed jointly by Hamilton Watch Company and Electro-Data, founded by George H. Thiess and started a new revolution wearable-devices.

Developments in the 2010s have included smartwatches, which are elaborate computer enabled electronic devices designed to be worn on a wrist. Their ubiquitous use today most likely has its initial roots in military and espionage needs. Although they generally incorporate timekeeping functions, this has become only a small fraction of current smartwatch capabilities. In addition to timekeeping, the user now has the ability to perform consumer purchases and with the invention of credit and debit cards, is able to transact business on an electronic basis as never before. Debit cards draw from a positive account balance maintained by the user and require verification of identification, usually a personal identification number (PIN) to complete a purchase.

“Smart Cards” are another recent transaction device that also requires a personal identification number to complete a transaction. Smart Cards, like debit cards, execute purchases from a positive account balance but the balance is maintained in the card itself. Additions to the card balance must be properly purchased and, typically, Smart Cards have safeguards against an illicit account increase.

Credit and debit-card purchases require the use of a physical card or at least its entry into a purchasing system by number. Users of Smart Cards are not immune to the disadvantages above. A buyer of goods from an automatic Smart Card-reading vending machine is required to swipe the card through a slot. The buyer is then required to enter a PIN to verify his or her identity and authorization for a purchase. Systems have begun to emerge that allow the non-contact use of Smart Cards through RF or infrared technology. However, a PIN must still be entered at some point in the transaction. If a Smart Card is stolen and the thief is able to acquire the rightful user's PIN, then there is no safeguard remaining to prevent the thief s access to the Smart Card's entire balance.

A reliable means of determining the identity of a potential user of a Smart Card, and thus whether that person is an authorized user, is by the use of biometric data identification. Biometric data is data taken from the measurement of some characteristic peculiar to an individual. A digitized thumbprint is an example of biometric data. Iris scans, speech pattern scans or various body temperatures, pH or even electrical characteristics are biometric data that can be used for validating the authenticity of an individual or groups of individuals.

In a system that uses biometric data for identification, a device that reads biometric data scans the relevant measurement of the candidate for identification. The attached system then compares the scanned data with data stored in the Smart Card. A match of data sets is then sufficient for identification.

A more recent implementation of such a scheme is the use of a thumbprint scanner which can read the user's thumbprint and determine whether it compares favorably with a stored thumbprint. If the user's data does not compare favorably, the system to which the identifying device is connected refuses to allow access to either on-board data or a network or, in some cases, a purchase. An iris scanner or a speech pattern reader functions similarly, though may be somewhat more difficult to implement. Systems using biometrics often still require physical contact between a user and a system and the system can be bulky and expensive. One solution to this issue has been to develop user-wearable electronic devices utilizing wireless transactions. These devices include devices that comprise a housing that houses a wireless communication device, one or more electronic circuits, a power source, a display device and a biometric data reading device. While enabled as a timepiece or performing other functions suitable to a user-wearable device (apparatus), the device can establish wireless communication with a counterpart communication apparatus in order to conduct a transaction. The biometric data reading device can read the user's applicable biometric data and then transmit a user identity validation and the wireless communication device can transmit user authorization for the transaction.

Although these devices enable efficient and user-friendly electronic transactions that do not require physical contact and employ biometric data reading in its operation, the need still exists for a user to be able to authorize a completely secured electronic transaction by having a wearable device that provides encryption for at least three vital aspects;
a) secured and uncompromised bio-identification of the user of the devices
b) secured and uncompromised communications and communication capabilities when using and/or wearing the devices
c) secured and uncompromised access to the devices and all data contained within the user-wearable devices

In addition, to the need for improved methods of securing communications between two or more communicating devices and/or users the use of blockchain can be added to not only provide enhanced security of the system described herein but also to use the system to enhance blockchain security.

Simply put, a blockchain is a type of distributed ledger or decentralized database that keeps continuously updated digital records of who owns what. Rather than having a central administrator like a traditional database such as utilized by banks, governments, accountants, etc., or in one location in the cloud, a distributed ledger has a network of replicated databases, synchronized (often via the internet) and visible to anyone within the network. Blockchain networks can be private with restricted membership similar to an intranet, or they can utilize public internets such as the World Wide Web which can be accessed by any person in the world.

When a digital transaction is carried out, it is grouped together in a cryptographically protected block with other transactions that have occurred in a segment of time (normally the last 10 minutes) and sent out to the entire network. Miners (members in the network with high levels of computing power) then compete to validate the transactions by solving complex coded problems. The first miner to solve the problems and validate the block receives a reward. (In the Bitcoin Blockchain network, for example, a miner would receive Bitcoins). Cryptocurrency and associated mining is what has led to popularizing the use of blockchain.

The validated block of transactions is then timestamped and added to a chain in a linear, chronological order. New blocks of validated transactions are linked to older blocks, making a chain of blocks that show every transaction made in the history of that blockchain. The entire chain is continuously updated so that every ledger in the network is the same, giving each member the ability to prove who owns what at any given time or any given instance.

According to Vitalik Buterin, the co-creator and inventor of Ethereurn (another cryptocurrency) , described as a “decentralized mining network and software development platform rolled into one” that facilitates the creation of new cryptocurrencies and programs that share a single blockchain (a cryptographic transaction ledger).

“A blockchain is a magic computer that anyone can upload programs to and leave the programs to self-execute, where the current and all previous states of every program are always publicly visible, and which carries a very strong crypto economically secured guarantee that programs running on the chain will continue to execute in exactly the way that the blockchain protocol specifies.”

Blockchain's decentralized, open and cryptographic nature allows people to trust each other and transact peer to peer, making the need for intermediaries obsolete. This also brings unprecedented security benefits. Hacking attacks that commonly impact large centralized intermediaries like banks would be virtually impossible to pull off on the blockchain. For example, if someone wanted to hack into a particular block in a blockchain, a hacker would not only need to hack into that specific block, but all of the proceeding blocks going back toward and including the entire history of that blockchain. The hacker/perpetrator would also need to carry out this procedure for every ledger in the network, which could include millions, and simultaneously.

Blockchain is a highly disruptive technology that promises to change the technology world as we know it today (2018). The technology is not only shifting the way we use the Internet, but it is also revolutionizing the global economy. By enabling the digitization of assets, blockchain is driving a fundamental shift from the Internet of information, where we can instantly view, exchange and communicate information to the Internet of value, where we can instantly exchange assets. A new global economy of immediate value transfer is on its way, where big intermediaries may no longer play a major role. An economy where trust is established not by central intermediaries but through consensus and complex computer code.

According to Don Tapscott, who is a Canadian business executive, author, consultant and speaker, and who specializes in business strategy, organizational transformation and the role of technology in business and society. He is the CEO of The Tapscott Group, and was founder and chairman of the international think tank New Paradigm before its acquisition, “The technology likely to have the greatest impact on the next few decades has arrived. And it's not social media. It's not big data. It's not robotics. It's not even AI. You'll be surprised to learn that it's the underlying technology of digital currencies like Bitcoin. It's called the blockchain.”

Blockchain has applications that go way beyond obvious things like digital currencies and money transfers. From electronic voting, smart contracts and digitally recorded property assets to patient health records management and proof of ownership for digital content.

Blockchain will profoundly disrupt hundreds of industries that rely on intermediaries, including banking, finance, academia, real estate, insurance, legal, health care and the public sector—amongst many others. This will result in job losses and the complete transformation of entire industries. But overall, the elimination of intermediaries brings mostly positive benefits. Banks and governments for example, often impede the free flow of business because of the time it takes to process transactions and regulatory requirements. The blockchain will enable an increased amount of people and businesses to trade much more frequently and efficiently, significantly boosting local and international trade. Blockchain technology would also eliminate expensive intermediary fees that have become a burden on individuals and businesses, especially in the remittances space.

Brock Pierce, who in 2013 founded venture capital firm Blockchain Capital (BCC) which was reported to have raised $85 million in two venture funds by October 2017 and announced a $50 million Initial Coin Offering (ICO) by BCC in February 2017 known as EOS and marketed through a new vehicle called Block.one that is developing “end-to-end solutions to bring businesses onto the blockchain from strategic planning to product deployment” , stated that “Every human being on the planet with a phone, will have equal access (to a form of blockchain). This expands the total addressable market by 4×”

In other words, perhaps most profoundly, blockchain promises to democratize and expand the global financial system. Giving people who have limited exposure to the global economy, better access to financial and payment systems. Stronger protection against corruption and exploitation is certainly one advantage that will make this technology more ubiquitous. The potential impacts of blockchain technology on society and the global economy are incredibly significant. With an ever-growing list of real-world uses, blockchain technology promises to have a massive impact.

Briefly summarizing, the blockchain works as a tamper-proof distributed public ledger that manages transactions. Another way to think of this is that blockchain is like a magical Google spreadsheet in the cloud, or more specifically on a network. Put simply, a blockchain is basically an incorruptible distributed ledger of data, which can be used to store informational assets ranging from managing cryptographic contracts to transferring value. The most recognized applications on a blockchain are bitcoin transactions. The transferring of value from one person to another with no central intermediary, and without allowing a person or party to spend their bitcoin (or other cryptocurrency) twice “the double spend rule”. This means that “value” can have a change of title and ownership from one person/party to another, without the need of a trusted third party to validate/govern the trade.

To accomplish this, the need for governance is found in the protocol. Besides being a ledger for “data of value”, or cryptocurrencies, blockchain technology is finding broader usage in peer to peer lending, (smart) contracts managements, healthcare data, stock transfers, and even elections. Like any emerging and disruptive technology, no one can predict the future of blockchain technology, but it is clear that it isn't (just) for purchasing black-market goods and services. In fact, blockchain technology is finding its way into big firms such as IBM, Microsoft, and major banking institutions. Interest in the technology is driven by (fear of disruption) the fact that it excludes trusted third parties (banks and clearinghouses) during transfer of values, which in turn results in fast, private and less expensive financial transactions.

As stated above, blockchain can facilitate the peer-to-peer transfer of anything that's of value. This may range from assets, properties, and contracts. The most crucial and far-reaching Blockchain applications is applied in Bitcoin, with transfer of value, and for Ethereum, with its enhancement of smart contracts.

As low-trust digital-based systems gain adherents and differing use cases, software developers are creating new variant blockchains to deal with the inevitable fragmentation between public, consortium and private blockchain technologies.

Here, it is important to understand the differences between public, consortium and private blockchains.

Public—Fully decentralized and uncontrolled networks with no access permission required—anyone can participate in the consensus process to determine which transaction blocks are added. There is usually little or no pre-existing trust between participants in a Public blockchain.

Consortium—The consensus process for new transaction blocks is controlled by a fixed set of nodes, such as a group of financial institutions where pre-existing trust is high.

Private—Access permissions are tightly controlled, with rights to read or modify the blockchain restricted to certain users. Permissions to read the blockchain may be restricted or public.

There is usually some degree of pre-existing trust between at least some of Private blockchain participants. The degree of pre-existing trust that an organization requires, as well as necessary control over participant permissions, will determine what type of blockchain to use. Different blockchain solutions have advantages and disadvantages. Take for example, the difference between how transactions are validated within each type of blockchain:

Proof of Work (PoW): About “mining” transactions utilizing a resource-intensive hashing process, which (a) confirms transactions between network participants and (b) writes the confirmed transactions into the blockchain ledger as a new block.

The accepted new block is proof that the work was done, so the miner may receive a 25 BTC (Bitcoins) payment for successfully completing the work. The problem with PoW is that it is resource-intensive and creates a centralizing tendency among miners based on computer resource capability.

Proof of Stake (PoS): About “validating” blocks created by miners and requires users to prove ownership of their “stake. Validation introduces a randomness into the process, making the establishment of a validation monopoly more difficult, thereby enhancing network security.

One problem with PoS is the “nothing at stake” issue, where miners have nothing to lose in voting for different blockchain histories, preventing a consensus from being created. There are several attempts to solve this problem underway. Additional developments in this area hope to combine PoW with PoS to create hybrid blockchains with the highest security and lowest resource requirements. To that end, some developers are focused on enhancing network security through ‘consensus without mining.’

Blockchains fundamentally operate on the basis of how consensus is agreed upon for each transaction added to the ledger.

To address the benefits of each type of consensus mechanism and in which situation are they best utilized, the following additional terms have been defined.

Delegated Proof of Stake—Network parameters are decided upon by elected delegates or representatives. If you value a “democratized” blockchain with reduced regulatory interference, this version is for you.

PAXOS—An academic and complicated protocol centered around multiple distributed machines reaching agreement on a single value. This protocol has been difficult to implement in real-world conditions.

RAFT—Similar to PAXOS in performance and fault tolerance except that it is “decomposed into relatively independent subproblems”, making it easier to understand and utilize.

Round Robin—Utilizing a randomized approach, the round robin protocol requires each block to be digitally signed by the block-adder, which may be a defined set of participants. This is more suited to a private blockchain network where participants are known to each other.

Federated Consensus—Federated consensus is where each participant knows all of the other participants, and where small sets of parties who trust each other agree on each transaction and over time the transaction is deemed valid. Suitable for systems where decentralized control is not an imperative.

Proprietary Distributed Ledger—A PDL is one where the ledger is controlled, or proprietary, to one central entity or consortium. The benefits of this protocol is that there is already a high degree of pre-existing trust between the network participants and agreed-upon security measures. Suitable for a consortium or group of trading partners, such as supply chains.

PBFT—In a PBFT system, each node publishes a public key and messages are signed by each node, and after enough identical responses the transaction is deemed valid. PBFT is better suited for digital assets which require low latency due to high transaction volume but do not need large throughput.

N2N—Node to node (N2N) systems are characterized by encrypted transactions where only the parties involved in a transaction have access to the data. Third parties such as regulators may have opt-in privileges. Suitable for use cases where a high degree of transaction confidentiality is required.

The above list represents the current major consensus mechanisms in operation or from research organizations.

Due to the initial visibility of Bitcoin, the financial services industry has been early in researching the possible uses of consensus mechanisms to streamline operations, reduce costs and eliminate fraudulent activity.

The multi-trillion dollar global financial services industry is really composed of many different sectors, from lending to smart contracts, trading execution, letters of credit, insurance, payments, asset registration, regulatory reporting and more.

For example, the process of securing a letter of credit, which is an important import/export trading service, would likely utilize a ‘consortium’ approach to achieving transaction consensus.

In August, 2016 a banking consortium, R3CEV, successfully designed and executed trading smart contracts. These types of contracts could then be applicable to accounts receivable invoice factoring and letter of credit transactions.

For the use case example of cross border remittances, which would involve many individuals on both sides of the transaction, a ‘public’ consensus mechanism would likely be a relevant choice.

Since remittances would need to have a relatively short time latency for transaction completion, a solution involving a Proof of Stake approach with its low resource requirement to validate transactions along with potentially higher security, would be compelling.

In sum, the state of blockchain development is rapidly gaining speed worldwide, yet there is much work to be done.

Numerous Global 2000 companies led by their technology executives and consultants are beginning to participate in development and testing of this revolutionary technology sector.

Organizations that begin first-hand learning about the power of blockchain technologies will have increased opportunity to lead their industry.

Existing Proof of Work and Proof of Stake protocols have various problems, such as requiring huge outlays of energy usage and increasing centralization (PoW) or participants having nothing at stake (PoS) possibly contributing to consensus disruption on mined blocks.

Tendermint co-founder Jae Kwon has published a paper describing his firm's concept and approach in this regard. Kwon's solution is twofold and does not require Proof of Work mining:

(a) A ⅔ majority of validators is required to sign off on block submission, with no more than ⅓ able to sign duplicate blocks without penalty

(b) The protocol raises the penalty of double-spend attacks to unacceptably high levels by destroying the malicious actor's Bitcoin account values.

The algorithm is “based on a modified version of the DLS protocol and is resilient up to ⅓ of Byzantine participants.”

Kwon and his team at Tendermint hope to bring speed, simplicity and security to blockchain app development.

An important and difficult to answer question remains. How does one decide on what type of blockchain to use and their relevancy for your company use case? The chart below provides a pathway for initial success.

Below are a few examples of different types of blockchains, depending on the organization's greatest prioritized need and a table which organizes these needs follows.

One consideration is confidentiality. For example, in the case of a public financial blockchain, all the transactions appear on the ledgers of each participant. So, while the identities of the transacting parties are not known, the transactions themselves are public.

Some companies are developing ‘supporting’ blockchains to avoid this problem, by “storing or notarizing the contracts in encrypted form, and performing some basic duplicate detection.” Each company would store the transaction data in their own database, but use the blockchain for limited memorialization purposes.

A second consideration is whether you need provenance tracking. Existing supply chains are rife with counterfeit and theft problems. A blockchain that collectively belongs to the supply chain participants can reduce or eliminate breaks in the chain as well as secure the integrity of the database tracking the supply chain.

A third example is the need for recordkeeping between organizations, such as legal or accounting communications. A blockchain that timestamps and provides proof of origin for information submitted to a case archive would provide a way for multiple organizations to jointly manage the archive while keeping it secure from individual attempts to corrupt it.

Blockchains fundamentally operate on the basis of how consensus is agreed upon for each transaction added to the ledger.

Understanding the differences between Private, Public and Consortium Blockchains is important.

As financial institutions begin to explore the possibilities of blockchain technology, they are coming up with systems that complement their existing business models. A private or a consortium blockchain platform, as opposed to the public platform that Bitcoin uses, will allow them to retain control and privacy while still cutting down their costs and transaction speeds.

In fact, this private system will have lower costs and faster speeds than a public blockchain platform can offer. Blockchain purists aren't impressed. A private platform effectively kills their favorite part of this nascent technology: decentralization. They see the advent of private blockchain systems as little more than a sneaky attempt by big banks to retain their control of financial markets.

The purists have a point, though the evil plot narrative is a bit much. If big banks can utilize a form of blockchain technology that revolutionizes finance, and if they are willing and able to pass these benefits onto their customers, then it is hardly an evil plot.

Vitalik Buterin said it best: “the idea that there is ‘one true way’ to be blockchaining is completely wrong headed, and both categories have their own advantages and disadvantages”. This is the purpose for addressing other possibilities as listed below;

### Public Blockchain

A Blockchain was designed to securely cut out the middleman in any exchange of asset scenario. It does this by setting up a block of peer-to-peer transactions. Each transaction is verified and synced with every node affiliated with the blockchain before it is written to the system. Until this has occurred, the next transaction cannot move forward. Anyone with a computer and internet connection can set up as a node that is then synced with the entire blockchain history. While this redundancy makes public blockchain extremely secure, it also makes it slow and wasteful.

The electricity (power requirements) needed to run each transaction is astronomical and increases with every additional node. The benefit is every transaction is public and users can maintain anonymity. A public blockchain is most appropriate when a network needs to be decentralized. It is also great if full transparency of the ledger or individual anonymity are desired benefits. Costs are higher and speeds are slower than on a private chain, but still faster and less expensive than the accounting systems and methods used today.

This is a good trade-off for a cryptocurrency like Bitcoin. Security is key to their users, a decentralized network is at the heart of the project and their competitors in the finance industry are still significantly more expensive and slower than a public blockchain network despite its slowness when compared to a private blockchain.

### Private Blockchain

Private blockchain lets the middleman back in, to a certain extent. It is similar to the statement “better the devil you know, than the devil you don't know. Here, the company writes and verifies each transaction. This allows for much greater efficiency and transactions on a private blockchain will be completed significantly faster. Though it does not offer the same decentralized security as its public counterpart, trusting a business to run a blockchain is no more dangerous than trusting it to run a company without blockchain. The company can also choose who has read access to their blockchain's transactions, allowing for greater privacy than a public blockchain.

A private blockchain is appropriate to more traditional business and governance models, but that isn't a bad thing. Just because it is unlikely to revolutionize our world, doesn't mean it can't play a role in making the world better. Competition is key to developing the most useful products. Traditional financial institutions have long held a monopoly—technically, an oligopoly—over the industry. Their outdated products and services are a direct result of this power. Using a privately run version of blockchain technology can bring these organization into the 21st century. A number of our governance institutions are old and outdated as well.

Like finance, our government is not subject to competition. Adoption and integration will likely be slower in this sector, but if and when blockchain technologies are adopted they will cut billions of dollars of behind the scenes spending.

Imagine a truly secure online voting system. No more poll workers, voting booths, paper ballots, paid counters or organizers with cushy salaries. What's more, the barriers to voting will be greatly reduced and we will likely see an increase in turnout.

This could be accomplished with a public design, but most governments are unlikely to decentralize control and security, so a vetted private system greatly increases the chance of adoption.

### Consortium Blockchain

Consortium blockchain is partly private. There has been some confusion about how this differs from a fully private system. Here again, Vitalik Buterin provides a pretty straightforward definition:

“So far there has been little emphasis on the distinction between consortium blockchains and fully private blockchains, although it is important: the former provides a hybrid between the ‘low-trust’ provided by public blockchains and the ‘single highly-trusted entity’ model of private blockchains, whereas the latter can be more accurately described as a traditional centralized system with a degree of cryptographic auditability attached.”

Instead of allowing any person with an internet connection to participate in the verification of transactions process or allowing only one company to have full control, a few selected nodes are predetermined. A consortium platform provides many of the same benefits affiliated with private blockchain—efficiency and transaction privacy, for example—without consolidating power with only one company. One can think of it as trusting a council of elders. The council members are generally known entities and they can decide who has read access to the blockchain ledger. Consortium blockchain platforms have many of the same advantages of a private blockchain, but operate under the leadership of a group instead of a single entity. This platform would be great for organizational collaboration.

Imagine central banks coordinating their activities based on international rules of finance. Another scenario could include the United Nations outsourcing their transactional ledger and voting system to blockchain, allowing each country to represent a verifying node.

A major concern and major objective of the present disclosure involves the fact that many people, institutions and corporations have the belief that even the blockchain is not completely secure and perhaps even corruptible.

In recent months, Bitcoin's supporters have pointed to its falling use in illegal transactions as a sign of the cryptocurrency's growth toward mainstream acceptance. But German researchers say that links to child pornography within technology underlying Bitcoin could stifle its development. While the blockchain is largely known to be an immutable ledger of Bitcoin transactions corroborated by copies held by participating computers, it also allows its users to leave coded messages. Bitcoin's creator, Satoshi Nakamoto, famously left a cryptic message on the blockchain's original block: “The Times 03/Jan/2009 Chancellor on brink of second bailout for banks.”

Like that very first message, most of the content left on the blockchain has been relatively benign—tributes to the late Nelson Mandela, or messages to loved ones on Valentine's Day. But the ones that could be illegal, containing links to child porn, for example, could be an outsized problem for the Bitcoin community.

“While most of this content is harmless, there is also content to be considered objectionable in many jurisdictions, e.g., the depiction of nudity of a young woman or hundreds of links to child pornography,” the paper authored by members of RWTH Aachen University and Goethe University read. “As a result, it could become illegal (or even already is today) to possess the blockchain, which is required to participate in Bitcoin.”

The study, from RWTH Aachen University, also states that other files on the blockchain may violate copyright and privacy laws. Researchers stated they had found eight files with sexual content. And three of these contained content “objectionable for almost all jurisdictions”. Two of these between them listed more than 200 links to child sexual abuse imagery.” Garrick Hileman, a crypto-currency expert at Cambridge University, stated that the issue of illegal content had been “discussed and known about for awhile.” Pruning, or altering parts of the blockchain ledger, would allow users to rid their local copies of illegal content, he said, but was likely to be too technical for most Bitcoin users. “There are big barriers anytime you need to make modifications,” Mr. Hileman said. But he also added that although maintaining a complete record of the blockchain was more secure than an altered copy, “many would argue that it's not that important”.

The researchers said they found 1,600 instances in which transactions on the blockchain included non-financial information, representing about 1.4% of transactions. Since the Bitcoin blockchain is immutable, those who download it are also unwittingly downloading links to child porn.

The Department of Justice did not respond to requests for comment from Fortune.

It's not the first time curious onlookers have found links to child pornography in Bitcoin's blockchain. Users first pointed out the links in 2013. Though this is perhaps the first time researchers have been able to quantify the volume of potentially illicit material hidden in the blockchain.

Additionally, since Bitcoin has buyers and traders all over the world, items in the blockchain also raise questions about legality in other nations. As the blockchain researchers note: “In China, the mere possession of state secrets can result in longtime prison sentences. Furthermore, China's definition of state secrets is vague and covers, e.g., activities for safeguarding state security. Such vague allegations with reference to state secrets have been applied to critical news in the past.”

The researchers pointed out that the blockchain includes online news articles concerning pro-democracy demonstrations in Hong Kong in 2014, demonstrations that were a point of irritation for Beijing.

In an effort to rebuke the possibility that blockchain may be less than secure and/or corruptible, a research paper published in July 2017 entitled “Data Insertion in Bitcoin's Blockchain” explores this topic in more detail and explains how the coinbase data “is arbitrary and can be up to 100 bytes in size”. This article states that only miners have the ability to insert data in this manner, and it's typically used to signal mining support for proposed protocol changes. There are five other ways in which data can be encoded on the bitcoin blockchain, and it is the OP RETURN option that is at the center of the child pornography story. The 2017 research paper explains that “this method is appropriate for inserting small amounts of data (or transaction metadata), but it is not suitable for large quantities of data.”

80 bytes is all that OP_RETURN can store, and what's more that information is subject to deletion. That's because bitcoin nodes are capable of pruning “provably unspendable” UTXOs for efficiency, which include OP_RETURN data. Anyone wishing to use the bitcoin blockchain to seek out child pornography would need to perform the following convoluted process:
1. Download the entire bitcoin blockchain and sift through 251 million transactions to find the 1.4% that contain some kind of arbitrary data encoded in them.
2. Ensure that the version of the blockchain you were using had been subject to no pruning that might have removed OP_RETURN data.
3. Extract any web links that might be concealed in the data using some sort of steganography.
4. Type the links into your browser until you eventually found a website that was still accessible.

To assert that the bitcoin blockchain contains child pornography is disingenuous, and is no more meaningful than saying that the internet contains CP. You could live to 100 and never encounter CP on the web, because that's not how the web works. And that's not how the blockchain works either.

Asserting that there is child pornography on the blockchain would be like strolling through the U.S. Capitol Building, dropping a scrap of paper containing a deep web address, and then claiming that the American government is storing obscene content. As respected bitcoin commenter Nic Carter wrote: “Any journalist writing about arbitrary content injection into the Bitcoin blockchain should be extremely careful to detail to what extent that content exists, is extractable, viewable, etc. A text string which is a URL link to a [website displaying a thing] is not [the thing itself]. That is an extremely bad interpretation. Do not conflate the two. If you are willing to claim that “the blockchain contains X” you should be able to prove that you can extract X.”

Steganography and blockchain data insertion are fascinating topics that deserve scrutiny and further study. To assert that the blockchain contains child pornography is misleading to the point of falsehood. It's possible to encode a hidden link inside any database, including Facebook, Twitter, and Wikipedia.

In any case, the present disclosure provides software developers with a new and better way to secure whatever software they're building so when that software communicates with either a copy of itself or other types of software, including the software resident in various types of devices, the data is kept safe. This application is specific to the ability to further secure one or more blockchains, which are already secure but have been reportedly hacked as stated above.

The present disclosure also relates generally to a cryptographic management scheme that provides for network security, mobile security, and specifically and more particularly relates to devices blockchain and a system for creating and manipulating encryption keys without risking the security of the key. The present disclosure addresses all of the needs described directly herein, as well as described earlier above. The basis of this disclosure is detailed below and includes the ability to both utilize one or more blockchains to enhance the securitization system for user wearable devices as well as utilize the system to provide additional securitization for one or more blockchains that are employed to deliver security for data transmission to and from these devices.

As it is known in cryptology, encryption techniques (codification) using standard and evolving algorithms are used so that data exposed to undesirable third parties are encrypted making it difficult (and intended to be impossible) for an unauthorized third party to see or use it. Usually, for encryption, the term ‘plaintext’ refers to a text which has not been coded or encrypted. In most cases the plaintext is usually directly readable, and the terms ‘cipher-text’ or ‘encrypted text’ are used to refer to text that has been coded or “encrypted”. Encryption experts also assert that, despite the name, “plaintext”, the word is also synonymous with textual data and binary data, both in data file and computer file form. The term “plaintext” also refers to serial data transferred, for example, from a communication system such as a satellite, telephone or electronic mail system. Terms such as ‘encryption’ and ‘enciphering’, ‘encrypted’ and ‘ciphered’, ‘encrypting device’ and ‘ciphering device’, ‘decrypting device’ and ‘decipher device’ have an equivalent meaning within cryptology and are herein used to describe devices and methods that include encryption and decryption techniques.

There is an increasing need for security in communications over public and private networks. The expanding popularity of the Internet, and especially the World Wide Web, have lured many more people and businesses into the realm of network communications. There has been a concomitant rapid growth in the transmission of confidential information over these networks. As a consequence, there is a critical need for improved approaches to ensuring the confidentiality of private information.

In spite of the great strides that have been made in network security, there still is a need for further improvement. For example, with the proliferation of heterogeneous network environments in which different host computers use different operating system platforms, there is an increasing need for a security mechanism that is platform independent. Moreover, with the increasing sophistication and variety of application programs that seek access to a wide range of information over networks, there is an increasing need for a security mechanism that can work with many different types of applications that request a wide variety of different types of information from a wide variety of different types of server applications. Furthermore, as security becomes more important and the volume of confidential network communications expands, it becomes increasingly important to ensure that security can be achieved efficiently, with minimal time and effort.

The creation of proprietary digital information is arguably the most valuable intellectual asset developed, shared, and traded among individuals, businesses, institutions, and countries today. This information is mostly defined in electronic digital formats, e.g., alphanumeric, audio, video, photographic, scanned image, etc. It is well known that a large number of encryption schemes have been used for at least the last 100 years and deployed more frequently since the onset of World Wars I and II. Since the beginning of the cold war, the “cat and mouse” spy missions have further promulgated the need for secure encryption devices and associated systems.

Simultaneously, there has been an increased need for mobility of transmissions including data and signals by physical or logical transport between home and office, or from office to office(s) among designated recipients. The dramatic increase in the velocity of business communications and the fusion of business, home, and travel environments has accelerated sharing of this proprietary commercial, government, and military digital information. To facilitate sharing and mobility, large amounts of valuable information may be stored on a variety of portable storage devices (e.g., memory cards, memory sticks, flash drives, optical and hard disc magnetic media) and moved among home and office PCs, portable laptops, PDAs and cell phones, and data and video players and recorders. The physical mobility of these storage devices makes them vulnerable to theft, capture, loss, and possible misuse. Indeed, the storage capacity of such portable storage devices is now approaching a terabyte, sufficient to capture an entire computer operating environment and associated data. This would permit copying a targeted computer on the storage media and replicating the entire data environment on an unauthorized “virgin” computer or host device.

Another trend in data mobility is to upload and download data on demand over a network, so that the most recent version of the data is always accessible and can be shared only with authorized users. This facilitates the use of “thin client” software and minimizes the cost of storing replicated versions of the data, facilitates the implementation of a common backup and long-term storage retention and/or purging plan, and may provide enhanced visibility and auditing as to who accessed the data and the time of access, as may be required for regulatory compliance. However, thin client software greatly increases the vulnerability of such data to hackers who are able to penetrate the firewalls and other mechanisms, unless the data is encrypted on the storage medium in such a way that only authorized users could make sense of it, even if an unauthorized user were able to access the encrypted files.

There is a balance among legal, economic, national security, and pragmatic motivations to develop robust security implementations and policies to protect the storage of proprietary digital information, based on the value of the information, the consequences of its exposure or theft, and the identification and trust associated with each of the targeted recipients. In order to provide such varying degrees of protection for portable storage devices, system methods and application functionality must be developed and easily integrated into the operating procedures of the relevant institutions. Different policies defining degrees of protection are required to economically accommodate and adapt to a wide range of targeted recipient audiences for this data.

Attacks on personal computers and commercial, government and military data are now commonplace; indeed, identity theft of passwords is the largest white-collar crime in the United States. Yet passwords and PINs (Personal Identification Numbers), in most cases generated by human beings who are tempted to use native-language words, Social Security Numbers, telephone numbers, etc., are still the most used access security methods for protecting portable encryption devices, and among the most vulnerable to both brute force dictionary attacks as well as sophisticated logic tracing. Professional criminal attackers and even amateur hackers now have access to sophisticated software and supercomputing networks that can unknowingly invade processing devices and storage devices, trace software instruction sequences and memory locations, and by knowing or discovering the algorithms being used, intercept and copy encryption keys, PINs, and other profile data used to protect the access to stored content. They can exploit vulnerabilities in the underlying commercial software, or in the construction of the integrated circuit chips housing and executing the cryptographic processes, or in the specialized cryptographic software, which enables exposing keys and access parameters at some deterministic point in the processing sequence. Industrial laboratory facilities are also available to read the data content stored in memory cells by measuring the electronic charge through the use of electronic beam microscopes, and thus steal stored PINs, keys, and therefore access the previously protected data.

Many methods exist for the key management protection necessary for securing key encryption keys for large groups of users. Split-key secret sharing schemes have been proposed whereby the decryption key is split and shared among multiple parties or entities to be combined to reconstitute the decryption key. In these cases, however, the individual secret shares themselves are maintained statically in multiple storage devices, generally on-line, where they are susceptible to attackers, particularly from within the institution, who can target the secret shares and recombine then to form the decryption key. Such solutions are often implemented for relatively static configurations of computing and storage devices and related communities of interest or tiers of users, and have not addressed the ability to so protect key encrypting keys when the data itself, and the means to encrypt and decrypt the data and to generate and recombine the shared secrets, are on a portable device.

Current file encryption systems provide a technique for a general-purpose computer to encrypt or decrypt computer-based files. Current encryption and decryption techniques typically rely on lengthy strings (e.g., 1024 bits, 2048 bits, 4096 bits, or more) to provide for secure encryption or decryption of files. Computer performance suffers due to the amount of data in the messages as well as the size of the encryption keys themselves.

Asymmetric file encryption systems use a different key to encrypt a file from the key used to decrypt the encrypted file. Many current file encryption systems rely on asymmetric encryption, such as those that rely on public key/private key pairs. An example of an encryption algorithm that utilizes public key/private key pairs is the RSA (Rivest, Shamir, and Adleman) algorithm. Symmetric file systems use an identical key to encrypt a file as the key used to decrypt the encrypted file. Certain file encryption systems utilize a cryptographic process or random number generator to derive a random symmetric key known as the file encryption key (FEK). The FEK is used to encrypt the file. Symmetric cryptography functions up to five orders of magnitude faster than asymmetric cryptography on files. Even with a very fast key device or software that encrypts/decrypts using the asymmetric key, any such file encryption system still has to overcome the fact that asymmetric keys generally operate at orders of magnitude slower than symmetric keys. When using the file encryption key, each time a file is being authenticated, the file encryption key has to be decrypted by the asymmetric key which is time consuming, but becoming less so as computer speeds and operations are constantly improving.

What is needed are highly robust and proven security techniques incorporated into new system methods and into new commercially available portable storage hardware apparatus to implement configurable security policies for accessing information through rigorous authentication means, to secure the information with certified levels of accepted cryptographic technology, and to rigorously control the environment within which the information is shared.

In addition, there is a need to better secure portable storage apparatus and method of encrypting and sealing digital information files and storing them in the device's integral or removable memory, or alternatively on the host device's memory or other ancillary memory storage devices, while operating under cryptographically protected security policies for transport and authorized access to such digital information.

There is also a need for secure physical and logical transport of data to and from multiple recipients. To this end, it is desirable to provide a means of securely transporting data from one place to another, if the user has to carry the data or physically transport the data and the secure encryption device, and somehow communicate the information necessary to log on and access the data by another authorized user. What is required are a multiplicity of methods to securely transport the encrypted data, either physically or logically, between an Originator user and one or more Receivers.

The use of encryption devices by the general population is becoming very common in for example, commercial electronic transactions and/or electronic mail. A predominant portion of all societies want to believe in an objective, easily verified way, that the maximum degree of the diffusion and confusion (encryption) of data and data values provided by a system they are using to encrypt their data, is the superior set of encrypted devices and system.

The present disclosure also relates generally to a cryptographic management scheme that provides for network security, mobile security and specifically and more particularly relates to devices and a system for creating and manipulating encryption keys without risking the security of the key while enhancing the security of the blockchain as well as utilizing the blockchain to enhance the security of the cryptographic management scheme. The present disclosure addresses all of the needs described directly herein, as well as described earlier above.

### SUMMARY

The present disclosure provides for one or more devices, methods, and systems for a user to enable and authorize a secured communication by having user-wearable devices that together with blockchain technology provide enhanced security for at least four vital functional needs;
a) secured and uncompromised bio-identification of the user of the devices
b) secured and uncompromised communications and communication capabilities when using and/or wearing the devices
c) secured and uncompromised access to the devices and all data contained within the user-wearable devices
d) providing inoperability to the devices once removed from the designated, authorized, and validated users.

Network security is a burgeoning field. There are well known encryption algorithms, authentication techniques and integrity checking mechanisms which serve as the foundation for today's secure communications. For example, public key encryption techniques using RSA and Diffie-Hellman are widely used. Well known public key encryption techniques generally described in the following U.S. Pat. No. 4,200,770 entitled, Cryptographic Apparatus and Method, invented by Hellman, Diffie and Merkle; U.S. Pat. No. 4,218,582 entitled, Public Key Cryptographic Apparatus and Method, invented by Hellman and Merkle; U.S. Pat. No. 4,405,829 entitled Cryptographic Communications System and Method, invented by Rivest, Shamir and Adleman; and U.S. Pat. No. 4,424,414 entitled, Exponentiation Cryptographic Apparatus and Method, invented by Hellman and Pohlig. For a general discussion of network security, refer to Network and Internetwork Security, by William Stallings, Prentice Hall, Inc., 1995.

Known encryption systems for these devices include the “Data Encryption Standard” (“DES”), which was initially standardized by the “American National Bureau of Standards”, currently “National Institute of Standards and Technology” (“NBS” or “NIST”) in the United States. Another includes the “Fast data encipherment algorithm FEAL” (FEAL) developed later in Japan, and described in the IECEJ Technical Report IT 86-33. U.S. Pat. No. 5,214,703 entitled “Device for the Conversion of a Digital Block and Use of Same” describes the use of additional devices as does an encryption device described in U.S. Pat. No. 5,675,653 entitled “Method and Apparatus for Digital Encryption”. In most cases, the user making use of protecting the data after encryption or enciphering of a plaintext has delegated the strength of the invulnerability of the encryption to be positioned in front of an enemy attack. This positioning is aimed to discover the contents of the cipher text or the encryption key used, trusting in the organizations, institutions, or experts endorsing their security and providing a degree of confusion and diffusion of values introduced by the encryption device used in the cipher text. The user encrypting a particular plaintext has no objective security regarding the degree of confusion and diffusion of values present in a cipher text that result from the application of the encryption device.

More specifically, this disclosure is specific to user-wearable devices that must be capable of receiving and sending secured communications associated with (in some cases continuous) bio-identification of the user as well as any communication that the user determines should be carried out with the user-wearable devices. These communications can include but are not limited to electronic, optical, radiative and other forms of signal generating energies and also utilize one or more securitized blockchains. These blockchains can be used for either real or virtual devices. Most often these signals will be transmitted in a wireless fashion. The blockchains can be further securitized using the system described or alternatively the system will be further securitized by utilizing the blockchains.

More specifically, the present disclosure describes;

One or more user-wearable communication secured devices, comprising: a housing; one or more computer driven communications processors containing a microprocessor and data storage encryption capacity fixedly mounted in the housing; one or more circuits fixedly mounted in the housing and communicatively coupled with the computer driven communications processors; a power source coupled with the circuits; at least one transceiver and a biometric data transceiver portion coupled with the housing and coupled with the circuits and with the communications processors such that one or more sensors are held within or on one or more surfaces of the devices;

wherein the devices transmit and receive encrypted signals that form specific transmissions determined by one or more users, that can utilize one or more securitized blockchains for the transmissions, to the transceiver;

wherein the transceiver determines, via authentication and validation, identification of the users and confirms if the users are wearing the devices via utilization of the computer driven communication processors that can utilize one or more securitized blockchain;

wherein the communication processors provide, process, and analyzes bio-identification, continuous bio-confirmation, and authentication of the users and utilizes the securitized blockchain as needed and wherein the authentication includes either high security or low security authentication requests and wherein the blockchain can be either real or virtual devices.

The circuits can be connected to sensors or themselves function as sensors. In addition, the circuits can be selected from the group consisting of; electronic, optical, and radiation emitting/receiving energized circuits that transmit and receive signals.

One or more display portions can be communicatively coupled with the circuits.

The housing maybe in the shape of a wristwatch, wherein the wristwatch incorporates features that provide functions for one or more devices selected from the group consisting of; a camera, a smartphone, a calculator, a global positioning system (GPS), a radio, a television, a door opener, or other remote energy switching device, and a transceiver, wherein the transceiver is capable of acting as an IP protocol data unit.

The housing can also be in a shape selected from the group consisting of; necklaces, broaches, rings, earrings, badges, belt buckles, assorted jewelry, and articles of clothing.

The signals carry data that is transmitted and received by the transceiver(s) and wherein the transceiver has an ability to analyze and act upon instructions contained within the data and can utilize one or more securitized blockchain.

The sensors are often biometric sensors that provide biometric data that contains information provided by one or more securitized blockchain and are used to confirm or deny access to user-wearable devices. The bio-identification initiates a process that requires user action to bio-identify user-wearers followed by initial bio-confirmation and then authentication of user-wearers to enable one or more communications wherein the communications are provided by one or more securitized blockchain.

The bio-identification is continuously confirmed by authentication requests such that if bio-confirmation is not confirmed, a de-authenticate procedure is initiated that utilizes one or more securitized blockchain(s) and that requires bio-identification confirmation must be re-initiated.

The authentication requests can be high security requests that require users actively re-bio-identify themselves in order for authentication requests to proceed and such that a test for bio-confirmation is maintained that results in a confirmation that allows for completion of authentication.

Alternatively, authentication requests can be low security requests that do not require re-bio-identification, and in this case such a test for bio-confirmation is maintained that results in a confirmation that allows for completion of authentication. Here, this authentication process utilizes one or more securitized blockchain(s). Authentication requests can be communicated to user-wearable devices from external sources or authentication requests can be user-initiated originating from user-wearable devices.

Users according to another aspect of this disclosure, are notified when encryption is initiated, in process, or completed, and wherein the notification utilizes one or more securitized blockchains.

The encryption is provided for transmissions during transmission of a credential identifier to control a server and utilizes one or more securitized blockchains.

The display portions can display timepiece data and/or communication data.

Further, the biometric transceiver is adapted to read information from one or more of a group consisting of: a user's fingerprints, voice patterns, a body's electrical, chemical, physical, and biological characteristics, biotags, facial characteristics, skin pH, thermal characteristics, ocular characteristics, kinesthetics, and genetic make-up and wherein users are defined as being any member of a genus of an animal or plant kingdom.

Power for the user-wearable devices may be obtained from a variety of sources including via a one or more of a group including a battery, a solar cell, and/or electromagnetic and/or radiative coupling from an external source.

Transmissions sent or received by the transceiver which optionally includes a biometric data transceiver portion of the transceiver and provides internal and external user identity validation for the devices that validate authentication via utilization of at least one distributed auto-synchronous array (DASA) database, wherein the DASA database contains and provides at least one authentication and encryption application and wherein the transmissions utilize one or more securitized blockchains.

The transmissions access and transmit a portion of data contained within the DASA database to the user-wearable devices, validates data transmitted from the user-wearable devices with a portion of data within the DASA database, and further establishes validity of data according to a set of instructions (which includes a set of rules) for data residing in the DASA database such that all transmissions incoming to, held within, and outgoing from the sensors or any transceivers of these devices, function securely and singularly for a specific, designated set of users and wherein the transmissions utilize one or more securitized blockchains.

The DASA database also provides one or more transmittable codes, wherein the codes originate within the authentication and validation applications and wherein the user-wearable devices communicate internally and externally by transmission and reception of data signals.

Codes are securitized in that the codes are not readily accessible from an external source or within the user-wearable devices without passing through a security check to ensure that proper access occurs. The codes should be encrypted utilizing cryptographic techniques described in this as well as the incorporated by reference applications listed above.

More specifically, the codes utilize authentication, validation, and encryption applications that authenticate, validate, and encrypt signals between detecting devices capable of searching, retrieving, analyzing, and validating the codes. Further, the codes are generated after installation of the authentication, validation, and encryption applications is complete.

The codes can be either recognizable or not recognizable by the user-wearable devices depending on the need during attempted authentication and validation. In addition, the codes can be selected from one or more of a group consisting of; a QR code, a bar code, a digital code, a temporal code, a binary code, an analogue code, and a 7-bit binary code.

The data within the DASA database can be in at least one embodiment, accessed, manipulated, and arranged by a computer driven communications processor residing within the devices described.

In most embodiments, the transmissions are wireless and the transmissions provide communications that are transmitted and received via oral, verbal, text, video, and data messaging so that the communications can be displayed.

In at least one embodiment, authentication is a challenge response system utilizing transmissions and one or more securitized blockchains wherein transmissions lead to one or more communications. The challenge response system utilizes communications that contain implicit or explicit logic and one or more securitized blockchains. Implicit logic requires a pre-arranged sets of data variables in a form of communications with one or more transceivers and one or more securitized blockchains, so that authentication can proceed. Alternatively, explicit logic requires creation and analysis of different sets of data variables in a form of communications with one or more transceivers, so that authentication can proceed.

In at least another instance, the form of communications can define a credential identifier. The credential identifier comprises at least some form of data such as meta data combined with at least one authentication. Further the credential identifier comprises at least some form of data such as meta data combined with authentication requests. The credential identifier includes at least one of the group consisting of meta data, authentication, and authentication requests that are encrypted and utilize one or more securitized software blockchain. The meta data includes an acknowledgement/non-acknowledgement portion that provides a path to determine access controlled by the server and/or the user-wearable devices that becomes one or more communications and utilizes one or more securitized blockchains.

In a further embodiment, the communications processor (which is a module in that it can be inserted and removed from the systems or devices as required) also includes an authentication processor (also can be a module) that performs a challenge response for the credential identifier by initially sending meta data to a server and utilizes one or more securitized blockchains. The authentication module is an input/output module that sends and receives transmission signals to and from the server in response to reception of the credential identifier and utilizes one or more securitized blockchain. The communication processor(s) is configured to transmit the credential identifier to access control of a server and utilizes one or more securitized blockchains via a wireless communication link. The communication processor(s) include an interface to data residing on a server so that a form of the data can be displayed on the user-wearable devices. This data can include metadata as well. The server can be configured to authenticate the credential identifier during comparison against entries of one or more keys (they are often in the form of cryptographic keys) within a set of data configuration tables residing in the DASA database and utilizes one or more securitized blockchains. The application is secured in a secured DASA database within a secured cloud or other secured storage device utilizing one or more encryption applications.

In an additional embodiment the encryption application(s) employs a step-wise process as follows; a user of one or more user-wearable devices invokes secured transmission as attempts to acquire a key using tolerance techniques that provide for a number of attempts (n) to retrieve keys from a configuration table, wherein the encryption application possesses a get next key computational operation (which often includes unique algorithms) that is invoked locally on or in proximity to the user-wearable devices. The encryption application also provides for generation of encryption keys as well as a new master key, and simultaneous attempts are made to match one or more user identification (ID) encryption keys within a user ID encryption key database and wherein the encryption application utilizes one or more securitized blockchains. A tolerance range allows for a search of matching encryption keys that synchronizes with the user ID encryption key database.

In at least one instance, the encryption application is added to provide additional security layers required for the user-wearable devices so that a proper match is determined and establishes whether a user of the user-wearable devices is allowed access privileges. If access is allowed, a user's user-wearable device provides via oral, visual, text, or data signal transmission that utilizes one or more securitized blockchains, a display that provides at least a derivation of the match so that the user is notified and allowed access. All encryption keys can be removed from the data configuration table either before, during, or after the match, such that a key management system exists and utilizes one or more securitized blockchains to ensure that the keys themselves are neither discoverable nor compromised. If access is denied, the user's user-wearable device provides via oral, visual, text, or data signal transmission that utilizes one or more securitized blockchains and is displayed as a denial of a match.

Lack of matching causes an encryption application that resides with the user's user-wearable device to be removed to further ensure that master keys in the data configuration table are protected and secured, a new master table key is generated either via a signal from the user devices to one or more secured DASA databases or via a signal from the key management system that utilizes one or more securitized blockchains.

The communications processor invokes use of at least one of the group of interfaces comprising a serial interface, a TCP/IP interface, an IEEE 802.11 interface, an IEEE 802.15.4 interface, and a secure HTTP interface.

A method for transmitting and receiving data signals from one or more user-wearable secured communication devices that utilize one or more securitized blockchains comprises: establishing communications with a communication counterpart; selecting a communication; reading and authenticating encrypted biometric data of the user of the devices; validating the user's biometric data; and transmitting an encrypted user identity validation upon successful validating of the user's biometric data, wherein transmissions sent or received by a transmissions transceiver portion of the devices is providing user identity validation for these devices via utilization of at least one DASA database that possesses an authentication and encryption application.

Another method that involves several aspects of this disclosure includes transmissions that are accessing and transmitting a portion of data contained within the distributed auto-synchronized database (DASA) to the user-wearable devices, validating data transmitted from the user-wearable devices with a portion of data held within the DASA database(s), and further establishing validity of data according to a set of instructions for data residing in the DASA database such that all transmissions incoming to, being held within, and outgoing from the circuits or any transceivers of the devices, are functioning in a secure manner for a specific, designated set of users.

Further, the DASA database provides one or more transmissible, securitized, and encrypted codes, wherein the codes originate within the authentication and encryption application, and wherein the user-wearable devices communicate internally and externally by transmission and reception of data signals that utilize authentication and encryption application(s). The transceivers function as detecting devices that search, retrieve, and analyze a code generated after installation of the authentication and encryption application is complete. The method includes the use of codes that are either recognizable or not recognizable by the user-wearable devices depending on the level of security required during attempted authentication and validation.

In at least one embodiment, communications and are enabled with Bluetooth technology. The communications can also be enabled with infrared technology. The communication could be a purchase, a command, and/or control of a switch, the communication can be selected from one or more of a group consisting of data, voice, and video transmissions that control hardware.

One of the methods includes providing a user's biometric data that is electronically stored within one or more memory storage systems selected from any one or more of a group consisting of; memory chips, internal or external servers, and a cloud data storage medium, that exist internally to or externally from the user devices. The communications may be disabled until the user's data is authenticated and validated and/or re-authenticated and revalidated.

In at least one other embodiment, a system is employed for one or more user-wearable communication secured devices for transmitting to and receiving data from one or more user-wearable secured communication devices to another that utilizes one or more securitized blockchains, comprising: establishing communications with a communication counterpart; selecting a communication; reading and authenticating encrypted biometric data of one or more users of the devices; validating the users' biometric data; and transmitting encrypted users identity validation upon successfully validating said users' biometric data, wherein transmissions sent or received by a transmissions transceiver portion of the devices is providing users' identity validation for the devices via utilization of at least one DASA database that possesses an authentication and encryption application.

The transmissions are allowed to access and transmit a portion of data contained within the auto-synchronized database to the user-wearable devices, validating data transmitted from the user-wearable devices with a portion of data held within the auto-synchronous database, and further establishing validity of data according to a set of instructions (that include rules) for data residing in the auto-synchronized database such that all transmissions incoming to, being held within, and outgoing from the circuits or any transceivers of the devices, are functioning in a secure manner for a specific designated set of users.

For the system, the DASA database provides one or more transmissible, securitized, and encrypted codes, wherein the codes originate within the authentication and encryption application, and wherein the user-wearable devices communicate internally and externally by transmission and reception of data signals that utilize the authentication and encryption application and wherein transceivers function as detecting devices that search, retrieve, and analyze a code generated after installation of the authentication and encryption application is complete. The system includes codes that are either recognizable or not recognizable by the user-wearable devices as required during attempted authentication and validation.

It is necessary to protect the content, quality and integrity of the authentication and associated authentication requests. In the present disclosure, this is accomplished, in part, by using a credential identifier that is sent or received during the authentication process. More specifically, utilization of meta data is combined with the authentication so that an acknowledgement/non-acknowledgement status can be achieved. This combination of meta data and authentication are the elements needed to create a credential identifier which can be encrypted. The meta data is describing what is being acknowledged or not acknowledged. Non-acknowledgement is not a necessary requirement of the authentication methodology. The encryption may be either static or dynamic. Dynamic encryption can utilize the DASA database in order to encrypt the meta data, the authentication, and/or the credential identifier. For the purposes of the present disclosure, encryption of the credential identifier or its associated elements (meta data and authentication) is not an absolute requirement.

In one instance of authentication, an encrypted credential identifier is provided to a control server. The authentication module communicating with the server is configured to authenticate the credential identifier against entries of one or more keys within a set of tables and an input/output module is configured to send and receive transmission signals to and from the credential identifier once the credential identifier has been successfully authenticated and/or validated.

In at least one embodiment, the encryption application employs a step-wise process as follows; a user of one or more user-wearable devices invokes secured transmission as attempts to acquire a key using a tolerance method are made.

The tolerance method provides for a number of attempts (n) to retrieve keys from a configuration table. The encryption application possesses a get next key computational operation or operations that is invoked locally on or in proximity to the user-wearable device. This encryption application allows for generation of encryption keys as well as generation of a new master key. Simultaneously, attempts are made to match one or more user identification (ID) encryption keys within a user ID encryption key database. A tolerance range is allowed to search for matching encryption keys which synchronizes with the user ID encryption key database.

In yet another embodiment, a system that employs secured user-wearable devices for transmitting to and receiving data from one or more user-wearable secured communication device(s) to another is also considered. The system utilizes the establishment of communications with a communication counterpart; selecting a communication; reading and authenticating encrypted biometric data of the user of the devices; validating the user's biometric data; and transmitting an encrypted user identity validation upon successfully validating the user's biometric data. The transmissions sent or received by a transmissions transceiver portion of the devices provides user identity validation for the devices via utilization of at least one DASA database that possesses an authentication and encryption application.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

Embodiments of the present invention are presented in the following drawings.

FIG. 1A illustrates one embodiment of a user-wearable device in the form of a wristwatch with a display for displaying data including time, date, and year.

FIG. 1B illustrates a second embodiment of a user-wearable device in the form of a wristwatch indicating two back panels of the same display which contact the user's wrist.

FIG. 2A is a flowchart indicating one technique by which a user is bio-identified and authenticated allowing and enabling the user to access and work with one or user-wearable devices.

FIG. 2B is a flowchart and subsection the flowchart of FIG. 2A, indicating one technique by which transmissions to and from one or more user-wearable devices are provided with encryption technology.

FIG. 3 is a flow chart that describes how a user can determine the need for utilizing blockchain technology for essentially any data application.

### DETAILED DESCRIPTION

Reference will now be made in detail to the one or more embodiments of the invention, examples of which are illustrated in the accompanying drawings.

These descriptions and representations provided so as to be understood by those skilled in the data processing arts to most effectively convey the substance of their work to others skilled in the art. A procedure, flow chart, logic block, process, etc., as presented here is to be generally understood as a self-consistent sequence of steps or instructions leading to a desired result. The steps are those requiring manipulations of physical quantities. Usually, though not necessarily, these quantities take the form of electrical, magnetic, and/or optical signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

For the purposes of this disclosure, the hierarchy associated with the user-wearable devices is a bottom up list as follows (meaning the hierarchy is a pyramid that begins at its pinnacle with circuits and ends at its base with communications);

Circuits that connect to devices and carry signals are described. The circuits can carry signals in one or more directions and the circuits may also be connected to sensors. These are further defined below as;
(a) Signals. that travel via one or more circuits
(b) Transmissions, that travel via signals
(c) Communications, that are transmitted via transmissions carried via signals over or through circuits
(d) Authentication(s) which are achieved and confirmed after communications are sent or received;
   and;

Communications that occur once authentication(s) are properly validated and completed and then are sent and/or received.

It should be borne in mind, however, that all of these and similar terms are to be associated with appropriate physical quantities and are merely convenient labels applied to these quantities. Unless specifically stated otherwise as apparent from the following discussions, it is appreciated that throughout the present disclosure, discussions utilizing terms such as “setting,” “storing,” “scanning,” “receiving,” “sending,” “disregarding,” “entering,” “establishing,” “selecting,” “reading,” “validating,” “transmitting,” or the like, refer to the action and processes of a computer system or similar intelligent electronic computing device, that manipulates and transforms data represented as physical (electronic/magnetic/optical) quantities within the computer system's registers and memories into other data similarly represented as physical quantities that is recognized by the same or other computer system memories or registers or other such information storage, transmission or display devices.

This discussion of this embodiment of the present disclosure that addresses the use of wearable user-devices that provide transmission communications, involving authentication and validation of a user's identity as an authorized user as well as encryption and decryption of data that is transmitted to, received by or otherwise resides on the devices themselves.

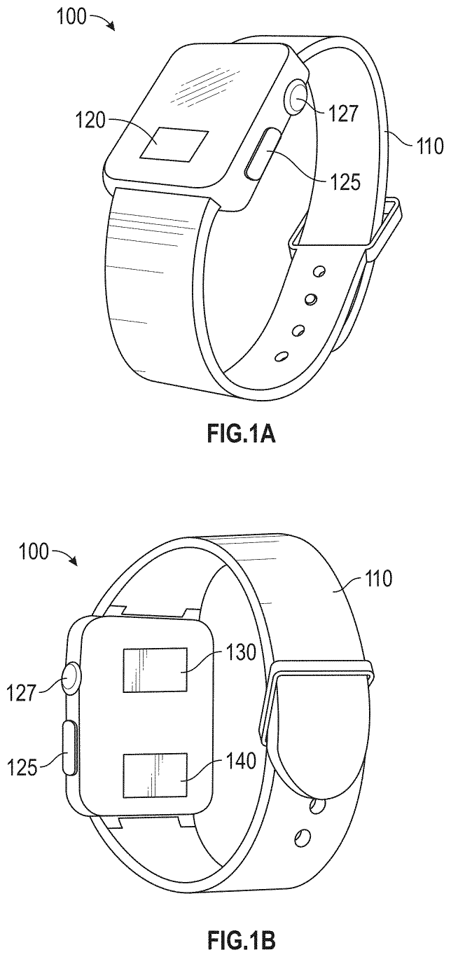

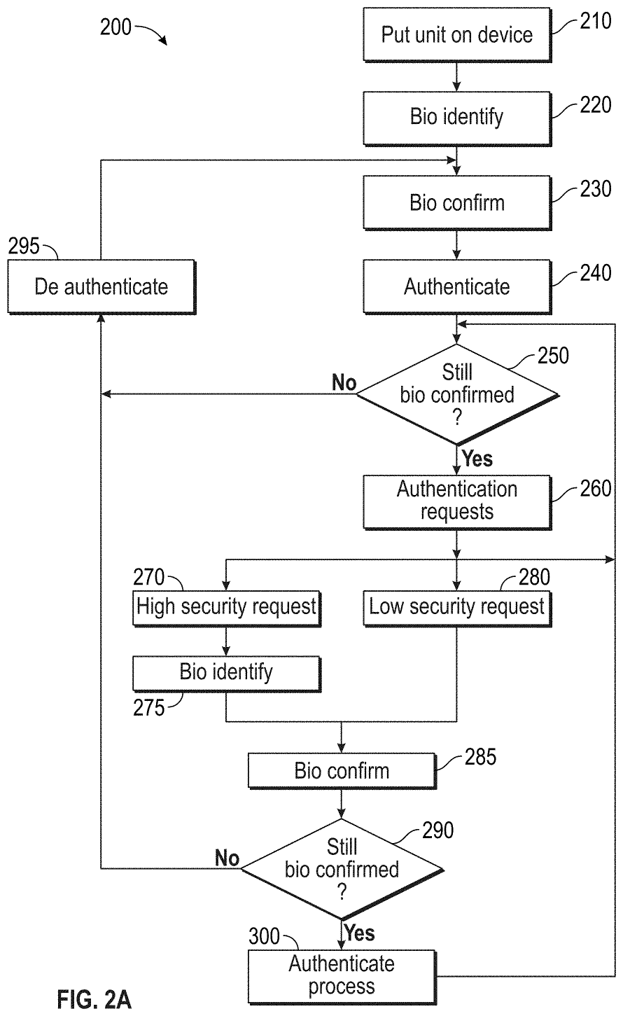

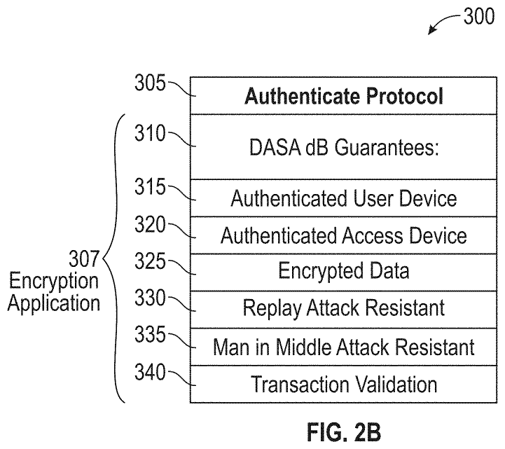

FIG. 1A, illustrates one embodiment of a user-wearable device in the form of a wristwatch with a display for displaying data including time, date, and year. One embodiment of the present disclosure is a device in the form of a wristwatch that benefits from high security of the transmission of data as well as biometric authentication and verification while remaining convenient for detailed communications. The security aspect is detailed below as it pertains to FIGS. 2A and 2B. For FIG. 1A, a user-wearable device (100) in the form of a wristwatch is shown with a wristband (110) which holds a panel and panel display portion (120). The user-wearable device in the form of a “smart watch” also provides for two additional features on the side of the panel and panel display portion (120) with a biometric transceiver shown as a sensor, including a mechanism for controlling power (125) to and from the device (100), as well as a scrolling mechanism (127) that allows for viewing information as necessary by the user. In FIG. 1B, the back portion of the device indicates two biometric transceivers shown as sensors (130 and 140) which can also act as sensor-scanners capable of transmitting, receiving, storing, and analyzing biometric data. This data from the user includes, for example a user's one or more fingerprints, voice patterns, body electrical characteristics, skin pH, thermal characteristics as well as all aspects of ocular characteristics. This data is used to authenticate and validate the user as earlier described in the summary of the invention, but is more specifically detailed according to the flow chart provided in FIGS. 2A and 2B. The data is transmitted via transmission that is encrypted and decrypted as required to ensure proper security. As stated above, the devices (100), have a housing with a computer driven communication processor fixedly mounted in the housing; one or more circuits fixedly mounted in the housing and communicatively coupled with the computer driven communication module; a power source electronically coupled with circuits; a display portion communicatively coupled with the circuits; at least one transmissions transceiver, and one or more biometric data transceivers (120, 130 and 140) in this case coupled with the back side of the display and electronically coupled with the circuits, transmissions transceiver, and with the communication module, wherein transmissions sent or received by the transmissions transceiver and the biometric data transceivers provide internal and external user identity validation for the devices. Validation is performed via utilization of at least one auto-synchronous database that possesses an authentication and encryption application. The transmissions access and transmit a portion of data contained within the auto-synchronized database to the user-wearable devices, validates data transmitted from the user-wearable devices with a portion of data within an auto-synchronous database, and further establishes validity of data according to a set of instructions for data residing in the auto-synchronized database such that all transmissions incoming to, held within, and outgoing from the circuits or any of the transceivers of the devices (including 130 and 140), function securely and singularly for a specific, designated set of users. The DASA database provides one or more transmissible, securitized, and encrypted codes such that the codes originate within the authentication and encryption application. The user-wearable devices communicate internally and externally by transmission and reception of data signals that utilize the authentication and encryption application so that the transceivers can function as detecting devices that search, retrieve, and analyze a code generated after installation of the authentication and encryption application is complete. The code is either recognizable or is not recognizable by the user-wearable devices during attempted authentication and validation. In one set of embodiments, the code is selected from the group consisting of; a QR code, a bar code, a digital code, an analogue code, and a 7-bit binary code. The auto-synchronous database is manipulated by the computer driven communication processor residing within the user-wearable devices.

In a specific embodiment the process (200) is outlined in the flowchart of FIG. 2, whereby as the user puts the device on (210) to make it wearable. This initiates a bio-identification (220) process described above that requires user action to bio-identify themselves, followed by initial bio-confirmation (230), and then authentication of the user-wearer (240). If after this initial process, the bio-identity is continuously confirmed (250) then if there are authentication requests (260), the process for these requests is initiated. It is important to note that authentication requests can be communicated to the user devices from external sources, or that the authentication requests can be user initiated from the user devices. If the bio-confirmation is not still confirmed, a de-authenticate procedure (290) begins which requires that a bio-identification (220) process must be re-initiated.

Referring back to the authentication requests (260), an option exists for either high security requests (270) or low security requests (280). The higher security requests (270) requires that the users actively re-bio-identify themselves (275) to continue the authentication process. A test for bio-confirmation (285) is maintained (290) resulting in transmission confirmation (300).

For lower security requests (280) the re-bio-identification step (275) is not required. It is possible, based on the present embodiment to keep the ease of simple communications unencumbered so that after the authentication request allowance (260) is performed, transmission to a lower security request occurs (280) and the transmission is allowed assuming that bio-confirmation (285) is maintained (290) resulting in transmission confirmation (300). Other security levels allowing for other authentication methods could also be invoked.

The choice here, regarding the encryption via the encryption application previously described will be according to the designer(s) of the user-wearable devices. Most likely encryption will be kept to a minimum for these lower security requests.

There are two feedback loops in continuous operation. The first loop continuously bio-confirms the user has not removed the device or that another user has taken the device. This loop returns to (250) which is the continuously confirmed bio-identity from either (260) ready to process authentication requests or (300) when an authentication request has been completed. The second loop de-authenticates the user (295) whenever the user has removed the device or another user has taken the device. These continuous feedback loops reassures the ability to ensure authentication.

Once transmission confirmation is reached (300) according to FIG. 2B, the authenticate protocol (305) triggers the use of the encryption application (307). This encryption application (307) utilizes the DASA database (310) and includes features (315, 320,325,330, 335, and 340) and guarantees a secure and specific connection with an authentic user is perfected (310). The authenticated user device (315) and the authenticated access device (320) are guaranteed by the synchronicity of keys within the DASA database. The DASA database encryption also guarantees fully encrypted data and transmission (325) of the data. The synchronicity of the keys within the DASA database is what blocks the ability to replay any communication (330). This blocking also prevents any third party “man-in-the-middle” piracy (335) from occurring, as the third party “hacker” would have to be able to establish the use of the continuously changing new codes to be able to confirm either bio-identity or to access the transmissions. Finally, the system ensures that the user of the wearable-user device is actually the user and not a third party requestor (340) by continuously checking biomarkers associated with the bio-identity of the user vs that of a “posing” requestor.

In the implementation of the embodiment envisioned, wearable-user devices can include a wearable piece of functional jewelry or other wearable accessories in addition to that of a smart watch. This implementation, not only houses the electronics and transceiver devices, it also provides both biometric and transmissions encryption applications to remove any security threat known. Note that, while this discussion focuses on the implementation of this embodiment as a smart watch which can function as a timepiece, many other implementations are envisioned, including wearable broaches, tie pins, cufflinks, belt buckles or even writing pens or PDA styli.

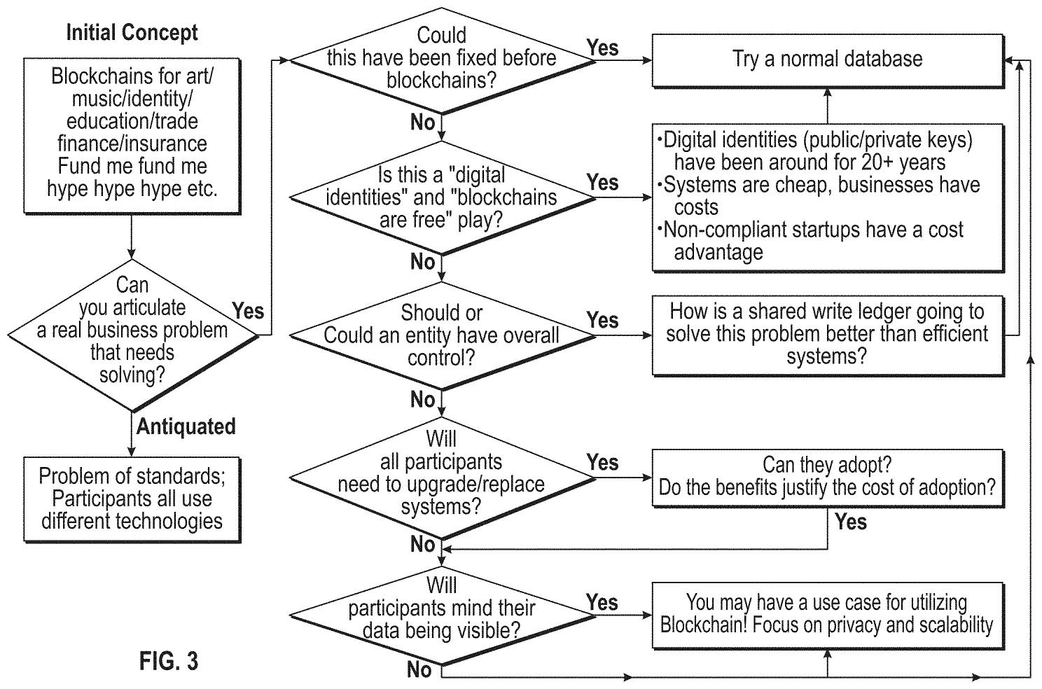

FIG. 3 is a flow chart that describes how a user can determine the need for utilizing blockchain technology for essentially any data application. This flowchart describes the possible needs and associated possible solutions that a user who is contemplating the use of blockchain can refer to when the questions shown arise. This flowchart is also of utility for users of the present disclosure, so they may also determine when to implement not only the protection afforded by the DASA database(s) and associated encryption/decryption devices and methods, but also if blockchain should be included or not.

Both the aforementioned implementations of this embodiment of the present invention provide opportunity for multiple levels of security. By requiring multiple levels, the secure limitation of the operation of the communicational capabilities regarding these embodiments to a single, specific user is virtually impenetrable.

The range of applications regarding transmissions and associated communications has no discernible limit. A few exemplary applications are outlined here in order to fully understand the need for securitizing such items as e-cash devices where the counterpart maybe an electronic wireless vending device. Another example could be the use of cars parking at a public parking meters or purchasing gasoline/diesel for automobiles, boats, or other modes of transportation. In fact the use of the user-wearable devices allows for the possible implementation of a proximity check that could be enabled by RF communications such as Bluetooth or use with GPS coordinates where it might be necessary to allow only very specific groups of users to access these transmissions and/or forms of communications. Military applications are also envisioned for essentially any war or peacetime activity where only certain individuals will be allowed access to the transmissions. Use of biometrics for each of these individuals could be based on various implantable wearable devices that emit signals specific only to that group.

The essence of these embodiments remains that of providing biometric data to validate a user's identity in order to authorize different communications. Though the embodiments presented herein have focused on implementation of the present invention as a smart watch, other devices could be implemented including writing instruments, key chains or other items easily and normally worn by users.

The embodiments of the present invention discussed herein present various implementations of a user-wearable electronic wireless communication device. These embodiments provide different ways to achieve an easy-to-incorporate form factor and convenience of operation in accomplishing communications wirelessly and without physical contact between the user-wearable device and any applicable counterpart device.

While the invention will be described in conjunction with these embodiments, it will be understood that they are not intended to limit the invention to these embodiments. Contrarily, the specification is intended to cover inventive alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details.

In other instances, well-known methods, procedures, components, and circuits have not been described in detail so as not to unnecessarily obscure aspects of the present invention. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

While most of the foregoing discussion about the present encryption technique has focused on the use of databases, lists and tables for storing communication specific codes, it may be preferred in some applications having limited memory to provide an algorithm for calculating the next communication specific code. The concept of “tolerance” described earlier may be incorporated either by setting an acceptable range of values for the communication specific code (output of the algorithm) or the designated portion itself (input to the algorithm), the later being the equivalent of back calculating the designated portion and verifying that it is within the range of tolerance.

In addition, each and every aspect of all references, patents, patent publications, and provisional applications mentioned herein are hereby fully incorporated by reference.

The computer readable media described within this application is non-transitory. The transmission of data is transmitted via signals that are non-transitory signals. In addition, each and every aspect of all US Provisional Applications and US Non-Provisional applications as well as any of the cited granted patents listed above are hereby fully incorporated by reference.

In compliance with the patent laws, the subject matter disclosed herein has been described in language more or less specific as to structural and methodical features. However, the scope of protection sought is to be limited only by the following claims, given their broadest possible interpretations. These and other objects and advantages of the present invention will become obvious to those of ordinary skill in the art after having read the following detailed description of the preferred embodiments which are illustrated in the various drawing figures.

The claims are not to be limited by the specific features shown and described, as the description above only discloses example embodiments. While the foregoing is directed to preferred embodiments of the present invention, other and further embodiments of the invention may be devised without departing from the basic scope thereof, and the scope thereof is determined by the claims which follow.

We claim:

1. One or more user-wearable transaction secured devices, comprising: a housing; a computer driven communication module containing a microprocessor and data storage encryption capacity fixedly mounted in said housing; one or more circuits fixedly mounted in said housing and communicatively coupled with said computer driven communication module; a power source coupled with said circuits; at least one transceiver and a biometric data transceiver portion coupled with said housing and coupled with said circuits and with said communication module such that one or more sensors are held within or on one or more surfaces of said devices;
wherein said devices transmit and receive encrypted signals that form specific transmissions determined by one or more users, that can utilize one or more securitized blockchain blockchains for said transmissions to said transceiver;
wherein said transceiver determines, via authentication and validation, identification of said users and confirms if said users are wearing said devices via utilization of said computer driven communication module that can utilize or more securitized blockchains;
wherein said communication module provides, processes, and analyzes bio-identification, continuous bio-confirmation, and authentication of said users and utilizes securitized blockchains as needed, and wherein said authentication includes either high security or low security authentication requests and wherein said blockchains are securitized via said authentication, validation, and encryption of said signals.

2. The user-wearable devices of claim 1, wherein said circuits are connected to sensors or themselves function as sensors and wherein said sensors are contained within, along, or external to one or more blockchains that may or may not be securitized blockchains.

3. The user-wearable devices of claim 1, wherein said circuits are contained within, along, or external to one or more blockchains and are selected from the group consisting of; electronic, optical, and radiation emitting/receiving energized circuits that transmit and receive signals.

4. The user-wearable devices of claim 1, wherein one or more display portions are communicatively coupled with said circuits such that said display portions are contained within, along, or external to one or more blockchains.

5. The user-wearable devices of claim 1, wherein said housing is in a shape of a wristwatch, wherein said wristwatch incorporates features that provide functions for one or more devices that are contained within, along, or external to one or more blockchains and selected from the group consisting of; a camera, a smartphone, a calculator, a global positioning system (GPS), a radio, a television, a door opener, or other remote energy switching device, and a transceiver, wherein said transceiver is capable of acting as an IP protocol data unit.

6. The secured user-wearable devices of claim 1, wherein said housing is in a shape selected from the group consisting of; necklaces, broaches, rings, earrings, badges, belt buckles, assorted jewelry, and articles of clothing.

7. The user-wearable devices of claim 1, wherein said signals carry data that is transmitted and received by said transceiver such that said signals are contained within, along, or external to one or more blockchains and wherein said transceiver can utilize one or more and has an ability to analyze and act upon instructions contained within, along, or external to one or more blockchains that include said data.

8. The user-wearable devices of claim 1, wherein said sensors are biometric sensors that provide biometric data that contains information provided by one or more blockchains and used to confirm or deny access to said user-wearable devices.

9. The user-wearable devices of claim 1, wherein said bio-identification initiates a process that requires user action to bio-identify user-wearers followed by initial bio-confirmation and then authentication of said user-wearers to enable one or more transactions wherein said transactions are provided by one or more blockchains.

10. The user-wearable devices of claim 9, wherein said bio-identification is continuously confirmed by authentication requests such that if bio-confirmation is not confirmed, a de-authenticate procedure is initiated that utilizes one or more blockchains and that requires bio-identification confirmation must be re-initiated.

11. The user-wearable devices of claim 10, wherein said authentication requests are high security requests that require users actively re-bio-identify themselves in order for said authentication requests to proceed and such that a test for bio-confirmation is maintained that results in a confirmation that allows for completion of authentication and wherein this authentication process utilizes one or more blockchains.

12. The user-wearable devices of claim 9, wherein said authentication requests are low security requests that do not require re-bio-identification, and such that a test for bio-confirmation is maintained that results in a confirmation that allows for completion of authentication.

13. The user-wearable devices of claim 9, wherein authentication requests can be communicated to said user-wearable devices from external sources or said authentication requests can be user initiated originating from said user-wearable devices both of which can be contained within, along, or external to one or more blockchains.

14. The user-wearable devices of claim 1, wherein said users are notified when encryption is initiated, in process, or completed and wherein said notification utilizes one or more blockchains.

15. The user-wearable devices of claim 14, wherein encryption is provided for transmissions during transmission of said credential identifier to control a server and utilizes one or more blockchains.

16. The user-wearable devices of claim 4, wherein said display portions display timepiece data.

17. The user-wearable devices of claim 4, wherein said display portions display transaction data.

18. The user-wearable devices of claim 1, wherein said biometric transceiver is adapted to read information contained within, along, or external to one or more blockchains from one or more of a group consisting of: a user's fingerprints, voice patterns, a body's electrical, chemical, physical, and biological characteristics, biotags, facial characteristics, skin pH, thermal characteristics, ocular characteristics, kinesthetics, and genetic make-up and wherein said users can include any member of a genus of an animal or plant kingdom.

19. The user-wearable devices of claim 1, wherein said power is obtained via a battery, a solar cell, and/or electromagnetic and/or radiative coupling from an external source.

20. The user-wearable devices of claim 1, wherein transmissions sent or received by said transceiver and a biometric data transceiver portion of said transceiver provide internal and external user identity validation for said devices that validate authentication via utilization of at least one distributed auto-synchronous array (DASA) database, wherein said DASA database contains and provides at least one authentication and encryption application and wherein said transmissions utilize one or more blockchains.

21. The user-wearable devices of claim 20, wherein said transmissions access and transmit a portion of data contained within said DASA database and contained within, along, or external to one or more blockchains to said user-wearable devices, validates data transmitted from said user-wearable devices with a portion of data within said DASA database, and further establishes validity of data according to a set of rules for data residing in said DASA database such that all transmissions incoming to, held within, and outgoing from said sensors or any transceivers of said devices, function securely and singularly for a specific, designated set of users and wherein said transmissions utilize one or more blockchains.

22. The user-wearable devices of claim 20, wherein said DASA database also provides one or more transmittable codes, wherein said codes exist within, along, or external to one or more blockchains and originate within said authentication and validation applications and wherein said user-wearable devices communicate internally and externally by transmission and reception of data signals that exist within, along, or external to one or more blockchains.

23. The user-wearable devices of claim 22, wherein said codes are securitized and exist within, along, or external to one or more blockchains in that said codes are not readily accessible from an external source or within said user-wearable devices without passing through a security check to ensure that proper access occurs.

24. The user-wearable devices of claim 22, said codes are encrypted and also exist contained within, along, or external to one or more blockchains.

25. The user-wearable devices of claim 22, wherein said codes utilize authentication, validation, and encryption applications that authenticate, validate, and encrypt signals between detecting devices that exist within, along, or external to one or more blockchains and are capable of searching, retrieving, analyzing, and validating said codes.

26. The user-wearable devices of claim 22, wherein said codes are generated after installation of said authentication, validation, and encryption applications are complete and wherein said applications exist within, along, or external to one or more blockchains.

27. The user-wearable devices of claim 22, wherein said codes are either recognizable or not recognizable by said user-wearable devices during attempted authentication and validation.

28. The user-wearable devices of claim 22, wherein said codes are selected from one or more of a group consisting of; a QR code, a bar code, a digital code, a temporal code, a binary code, an analogue code, and a 7-bit binary code.

29. The user-wearable devices of claim 20, wherein data within said DASA database and contained within, along, or external to one or more blockchains is accessed, manipulated, and arranged by said computer driven communication module residing within said devices.

30. The user-wearable devices of claim 1, wherein said transmissions are wireless and exist within, along, or external to one or more blockchains and wherein said transmissions provide communications that are transmitted and received via oral, verbal, text, video, and data messaging exists within, along, or external to one or more blockchains and wherein said communications can be displayed via utilization of one or more blockchains.

31. The user-wearable devices of claim 1, wherein one said authentication is a challenge response system utilizing said transmissions and one or more blockchains wherein said transmissions lead to one or more transactions that are contained within, along, or external to one or more blockchains.

32. The user-wearable devices of claim 32, wherein said challenge response system utilizes communications that exist within, along, or external to one or more blockchains and that contain implicit or explicit logic and one or more securitized blockchains.

33. The user-wearable devices of claim 33, wherein said implicit logic requires a pre-arranged sets of data variables in a form of communications with one or more transceivers that utilize one or more blockchains, so that authentication can proceed.

34. The user-wearable devices of claim 33, wherein said explicit logic requires creation and analysis of different sets of data variables in said form of communications with one or more transceivers and one or more blockchains, so that authentication can proceed.

35. The communications of claim 33, wherein said form of communications define a credential identifier.

36. The credential identifier of claim 35, wherein said credential identifier comprises at least some form of data such as meta data contained within, along, or external to one or more blockchains and combined with said authentication.

37. The credential identifier of claim 35, wherein said credential identifier comprises at least some form of data such as meta data contained within, along, or external to one or more blockchains and combined with authentication requests.

38. The credential identifier of claim 37, wherein at least one of the group consisting of meta data, authentication, and authentication requests are encrypted and utilize one or more blockchains.

39. The credential identifier of claim 38, wherein said meta data includes an acknowledgement/non-acknowledgement portion that provides a path to determine access controlled by said server and/or said user-wearable devices that becomes one or more transactions contained within, along, or external to one or more blockchains.

40. The user-wearable devices of claim 38, wherein said communication module also includes an authentication module that performs a challenge response for said credential identifier by initially sending meta data to a server contained within, along, or external to one or more blockchains. and utilizes one or more securitized blockchain.

41. The authentication module of claim 40, wherein said authentication module is an input/output module that sends and receives transmission signals to and from said server contained within, along, or external to one or more blockchains in response to reception of said credential identifier.

42. The user-wearable devices of claim 40, wherein said communication module is configured to transmit said credential identifier to access control of a server via a wireless communication link contained within, along, or external to one or more blockchains.

43. The user-wearable devices of claim 42, wherein said communication module includes an interface to data residing on said server and utilizes blockchains wherein a form of said data can be displayed on said user-wearable devices.

44. The user-wearable devices of claim 43, wherein said server is configured to authenticate said credential identifier during comparison against entries of one or more keys within a set of data configuration tables residing in said DASA database contained within, along, or external to one or more blockchains.

45. The encryption application of claim 20, wherein said application is secured in a secured DASA database within a secured cloud or other secured storage device utilizing said encryption application and utilizes one or more blockchains.

46. The encryption application of claim 20, wherein said application employs a step-wise process as follows;
a user of one or more user-wearable devices invokes secured transmission contained within, along, or external to one or more blockchains as attempts to acquire a key using tolerance techniques that provide for a number of attempts (n) to retrieve keys from a configuration table, wherein said encryption application possesses a get next key algorithm that is invoked locally on or in proximity to said user-wearable devices and wherein said encryption application utilizes one or more blockchains.

47. The encryption application of claim 46, wherein said application provides generation of encryption keys as well as a new master key contained within, along, or external to one or more blockchains, and simultaneous attempts are made to match one or more user identification (ID) encryption keys within a user ID encryption key database contained within, along, or external to one or more blockchains and wherein said encryption application utilizes one or more blockchains.

48. The encryption application of claim 46, wherein a tolerance range allows for a search of matching encryption keys that synchronizes with said user ID encryption key database contained within, along, or external to one or more blockchains.

49. The encryption application of claim 46, wherein said application is added to provide additional security layers contained within, along, or external to one or more blockchains and required for said user-wearable devices so that a proper match is determined and establishes whether a user of said user-wearable devices is allowed access privileges.

50. The encryption application of claim 46, wherein if access is allowed, a user's user-wearable device provides via oral, visual, text, or data signal transmission that utilizes one or more blockchains, a display that provides at least a derivation of said match so that said user is notified and allowed access.

51. The encryption application of claim 46, wherein all encryption keys can be removed from said data configuration table either before, during, or after said match contained within, along, or external to one or more blockchains, such that a key management system exists and utilizes one or more blockchains to ensure that said keys themselves are neither discoverable nor compromised.

52. The encryption application of claim 46, wherein if access is denied, said user's user-wearable device provides via oral, visual, text, or data signal transmission that utilizes one or more blockchains and is displayed as a denial of said match.

53. The encryption application of claim 46, wherein lack of matching causes said encryption application that resides with said user's user-wearable device is removed and wherein to further ensure that master keys in said data configuration table are protected and secured, a new master table key is generated either via a signal from said user devices to one or more secured DASA databases or via a signal from said key management system all contained within, along, or external to one or more blockchains, wherein said system utilizes one or more blockchains.

54. The user-wearable devices of claim 1, wherein said communication module invokes use of at least one of the group of interfaces comprising a serial interface, a TCP/IP interface, an IEEE 802.11 interface, an IEEE 802.15.4 interface, and a secure HTTP interface.

55. A method for transmitting and receiving data signals contained within, along, or external to one or more blockchains from one or more user-wearable secured transaction devices that utilize one or more blockchains comprising: establishing communications with a transaction counterpart; selecting a transaction; reading and authenticating encrypted biometric data of said user of said devices; validating said user's biometric data; and transmitting an encrypted user identity validation upon successful validating of said user's biometric data, wherein transmissions sent or received by a transmissions transceiver portion of said devices is providing user identity validation for said devices via utilization of at least one DASA database that possesses an authentication and encryption application all of which is contained within, along, or external to one or more blockchains.

56. The method of claim 55, wherein said transmissions are contained within, along, or external to one or more blockchains and are accessing and transmitting a portion of data contained within said auto-synchronized database to said user-wearable devices, validating data transmitted from said user-wearable devices with a portion of data held within said DASA database, and further establishing validity of data according to a set of rules for data residing in said DASA database such that all transmissions incoming to, being held within, and outgoing from said circuits or any transceivers of said devices, are functioning in a secure manner for a specific, designated set of users.

57. The method of claim 55, wherein said DASA database is providing one or more transmissible, securitized, and encrypted codes, wherein said codes originate within said authentication and encryption application, and wherein said user-wearable devices communicate internally and externally by transmission and reception of data signals that utilize one or more blockchains and said authentication and encryption application and wherein transceivers function as detecting devices that search, retrieve, and analyze a code generated after installation of said authentication and encryption application is complete and wherein said method is contained within, along, or external to one or more blockchains.

58. The method of claim 57, wherein said codes are either recognizable or is not recognizable by said user-wearable devices during attempted authentication and validation contained within, along, or external to one or more blockchains.

59. The method of claim 55, wherein said communications and are enabled with Bluetooth technology contained within, along, or external to one or more blockchains.

60. The method of claim 59, wherein said communications are enabled with infrared technology contained within, along, or external to one or more blockchains.

61. The method of claim 55, wherein said transaction is contained within, along, or external to one or more blockchains and is a purchase, a command, and/or control of a switch, and wherein said transaction is selected from one or more of a group consisting of data, voice, and video transmissions that control hardware.

62. The method of claim 55, wherein said user's biometric data is electronically stored within, along, or external to one or more blockchains and one or more memory storage systems selected from any one or more of a group consisting of; memory chips, internal or external servers, and a cloud data storage medium, that exist internally to or externally from said devices.

63. The method of claim 55, wherein said communications are disabled until said user's data is authenticated and validated and/or re-authenticated and revalidated and utilizes one or more blockchains.

64. A system that employs one or more user-wearable transaction secured devices for transmitting to and receiving data contained within, along, or external to one or more blockchains from one or more user-wearable secured transaction devices to another that utilizes one or more blockchains comprising: establishing communications with a transaction counterpart; selecting a transaction; reading and authenticating encrypted biometric data of one or more users of said devices; validating said users' biometric data; and transmitting encrypted users identity validation upon successfully validating said users' biometric data, wherein transmissions sent or received by a transmissions transceiver portion of said devices is providing users identity validation for said devices via utilization of at least one DASA database that possesses an authentication and encryption application all of which are contained within, along, or external to one or more blockchains.

65. The system of claim 64, wherein said transmissions contained within, along, or external to one or more blockchains are accessing and transmitting a portion of data contained within said auto-synchronized database to said user-wearable devices, validating data transmitted from said user-wearable devices with a portion of data held within said auto-synchronous database, and further establishing validity of data according to a set of rules for data residing in said auto-synchronized database such that all transmissions incoming to, being held within, and outgoing from said circuits or any transceivers of said devices, are functioning in a secure manner for a specific, designated set of users.

66. The system of claim 64, wherein said DASA database contained within, along, or external to one or more blockchains is providing one or more transmissible, securitized, and encrypted codes, wherein said codes originate within said authentication and encryption application, and wherein said user-wearable devices communicate internally and externally by transmission and reception of data signals that utilize said authentication and encryption application and wherein transceivers function as detecting devices that search, retrieve, and analyze a code generated after installation of said authentication and encryption application is complete all of which are contained within, along, or external to one or more blockchains.

67. The system of claim 66, wherein said codes are either recognizable or not recognizable by said user-wearable devices during attempted authentication and validation via one or more blockchains.
